(19) United States
(12) Patent Application Publication
(10) Pub. No.: US 2008/0203968 A1
(43) Pub. Date: Aug. 28, 2008

(54) MULTIPLE CHARGING UNIT

(76) Inventor: Christopher D. Campbell, Riverside, CA (US)

Correspondence Address: SNELL & WILMER LLP (OC), 600 ANTON BOULEVARD, SUITE 1400, COSTA MESA, CA, 92626, US

(21) Appl. No.: 11/680,029

(22) Filed: Feb. 28, 2007

(51) Int. Cl. H02J 7/00

(52) U.S. Cl. 320/116; 320/103; 320/106

(57) ABSTRACT

A multiple charging unit for charging different batteries and/or electronic devices at the same time. The charging units can be removably interchangeable from a housing unit or relatively fixed into the housing unit, and can be adapted to attach a variety of batteries and/or electronic devices. The charging units can also work in conjunction with a communication unit to allow attached electronic devices to communicate with other attached electronic devices or an outside electronic device. The multiple charging unit can also have a data retention unit to store data from attached electronic devices and/or transmit stored data to attached electronic devices.

### BACKGROUND

1. Field of the Invention

The present invention relates to improvements in chargers and more specifically to a new and improved charger capable of handling multiple types of batteries and/or electronic devices, allowing attached electronic devices to communicate with other attached devices and outside electronic devices, and also allowing attached devices to store and/or retrieve data.

2. Description of the Related Art

With the increase of inventions in modern technology, there is a boom in the development of electronic devices such as cell phones, personal digital assistants (“PDAs”), cameras, blackberrys®, handheld video game consoles such as PSP®, video players, or music players. While many electronic devices were originally novelty items that few could afford, they have rapidly gained popularity within society. Nowadays, electronic devices are so popular that they are often considered a necessity. However, each electronic device needs to be charged to function and each electronic device oftentimes has a unique charging unit associated with it.

Thus, a consumer must utilize various different charging units to charge all of his/her electronic devices. This can be cumbersome because of the sheer quantity of electronic devices that a user possesses. The user can have problems keeping track of the location of all of the charging units.

The problem can also be exacerbated when some users own not only various types of electronic devices, but also multiple quantities of each type of electronic devices such as two different cell phones or three different music players. This can be particularly true for a businessman or a family. In that scenario, chargers for each type of electronic device can look similar to each other, yet are not functionally equivalent. For example, a user with cell phone model “A” and “B” may use two different chargers for “A” and “B.” However, the chargers will look similar and the user will have a hard time distinguishing them apart from each other.

The charging units may also come in various shapes and sizes. This creates a problem when a user wants to store the charging units because the lack of uniformity makes it harder to utilize storage space efficiently. The user will usually have to use more space than he wants to store all of the charging units.

Also, many charging units may only charge electronic devices alone and do not charge batteries alone or vice versa. This is cumbersome because sometimes the user may want to charge only the electronic device and at other times the user may want to charge only the battery.

The sheer quantity of electronic devices that need to be charged is also problematic because of the limited number of electrical sockets in a given location. When the user needs to charge more than one electronic device at a time, all of the electrical sockets may be taken up. However, there may not be enough electrical sockets available even when a power strip is used due to the number of electrical devices that require charging.

Problems with owning multiple electronic devices are not limited to just charging the electronic device. Electronic devices oftentimes derive much of their usefulness from being able to communicate with other electronic devices such as a computer. However, like charging units, each electronic device oftentimes has their own unique communication cable to communicate with computers. This requires the user to assemble a collection of multiple communication cables that can be tangled or lost. A user can also be confused with the collection of multiple communication cables since many of them look similar. The user may then accidentally grab the wrong communication cable.

Furthermore, even if the user utilizes the correct communication cable, computers usually only have limited communication terminals to communicate with the electronic device. The communications cables have to be switched when the computer wants to communicate with a different electronic device. Thus, it can be difficult to transfer data from multiple electronic devices.

The requirement for multiple communication cables can also be problematic since the electronic devices may have a small amount of memory. This requires constant transfers of data from the electronic device to the computer. This especially a problem if the user loses the electronic device, has it stolen, or acquires a new electronic device. The data will be lost or will be cumbersome to transfer from the old electronic device to the new electronic device.

Therefore, there is a need for an apparatus that provides an easy way to charge multiple electronic devices and/or batteries and to transfer data to and from multiple electronic devices.

### SUMMARY OF THE INVENTION

The invention seeks to solve the problems described above. The invention utilizes a housing with a power distribution unit within the housing. The power distribution unit can be adapted to receive a car charger.

There is a plurality of charging units connected to the power distribution unit wherein at least two of the plurality of charging units are adapted to attach to two different electronic devices, and the power distribution unit converts voltages such that each of the plurality of charging units receives the correct voltage.

The invention can also have a communication unit connected to the power distribution unit, at least one of the plurality of charging units allowing an attached electronic device to communicate data with an outside electronic device, and/or at least two of the plurality of charging units allowing two attached electronic devices to communicate with each other.

Optionally, at least one of the plurality of charging units is adapted to attach to a battery without an electronic device attached to the battery. The charging units can be removably interchangeable with other charging units not currently connected to the power distribution unit or remain relatively fixed within the housing unit. It is contemplated that at least one of the plurality of charging units may be capable of communicating data with an attached electronic device.

Furthermore, the communication unit can work in conjunction with at least one of the plurality of charging units capable of communicating data with the attached electronic device, to allow the outside electronic device to communicate data with the attached electronic device. The communication unit could also facilitate communications between two attached electronic devices.

The charging units can also allow two attached electronic devices to communicate with each other without the aid of the communication unit, or possibly with the aid of the communication unit. Data to be transferred can include for example, songs, phonebooks, calendars, videos, text messages, picture messages, pictures, etc.

The housing can also have first display units to indicate whether each of the plurality of charging units is charging a battery or an attached electronic device, second display units to indicate whether each of the plurality of charging units is transmitting data, and/or third display units to indicate whether each of the plurality of charging units has finished charging an attached battery or an attached electronic device.

It is also contemplated that the invention could have a data retention unit for storing data from the attached electronic device and retaining the data from the attached electronic device after the attached electronic device has been detached. The data retention unit could also transmit stored data to an attached electronic device. This could help users keep information and/or data safe and retainable if electronic devices are lost or stolen, or if new devices are purchases so data can be transferred to it. Data stored can include for example, songs, phonebooks, calendars, videos, text messages, picture messages, pictures, etc.

The invention can also have storage units for storing charging units that are not connected to the power distribution unit. It can also have a strap attached to the housing.

One charging unit can be adapted to charge a music player, while another charging unit can be adapted to charge a PDA, still another charging unit can be adapted to charge a cell phone, while another charging unit can be adapted to charge a handheld video game such as a PSP®, furthermore, another charging unit can be adapted to charge a handheld video player, and yet another charging unit can be adapted to charge a camera.

To use the invention, a user would attach one or more electronic devices to one or more appropriate charging units. If the appropriate charging unit is not already attached to the power distribution unit, the user can swap one of the charging units for the appropriate charging unit. The user can then store any unconnected charging units in the storage unit. In addition, the user can also attach batteries that are not connected to electronic devices to appropriate charging units that are adapted to charge batteries. Also, the user can, for example, charge multiple electronic devices at the same time, charge multiple batteries at the same time, or charge a mix of electronic devices and batteries at the same time.

In addition, the invention can allow the electronic devices to store data within the invention and exchange data with another electronic device such as phone numbers, calendars, videos, text messages, picture messages, pictures, music, etc. This can allow users to keep information/data safe and retainable if the electronic devices are lost or stolen. The user can also transfer the information/data to new electronic devices.

The first display units can indicate that the particular charging unit is active such as when it is charging an attached electronic device or battery. The second display units can indicate that the charging unit is working in conjunction with the communication unit to transmit data from the attached electronic device to the outside electronic device or between two attached electronic devices. The third display units can indicate that the charging unit has finished charging the electronic device or battery.

To transfer data from the attached electronic device to an outside electronic device, the user can attach a cable to the communication unit from the outside electronic device. The attached electronic device and the outside electronic device can then communicate with each other to transfer data to and from the attached electronic device.

The user can use the strap to carry the invention.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a top view of a multiple charging unit according to an embodiment of the invention.

FIG. 2 is a rear view of the multiple charging unit of FIG. 1 according to an embodiment of the invention.

FIG. 3 is a left side view of the multiple charging unit of FIG. 1 according to an embodiment of the invention.

FIG. 4 is a right side view of the multiple charging unit of FIG. 1 according to an embodiment of the invention.

FIG. 5 is a front view of the multiple charging unit of FIG. 1 according to an embodiment of the invention.

### DETAILED DESCRIPTION

Reference will now be made in detail to the preferred embodiments of the invention, which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be obvious to one of ordinary skill in the art that the invention may be practiced without these specific details. In other instances, well known methods, procedures, components, and circuits have not been described in detail as not to unnecessarily obscure aspects of the invention.

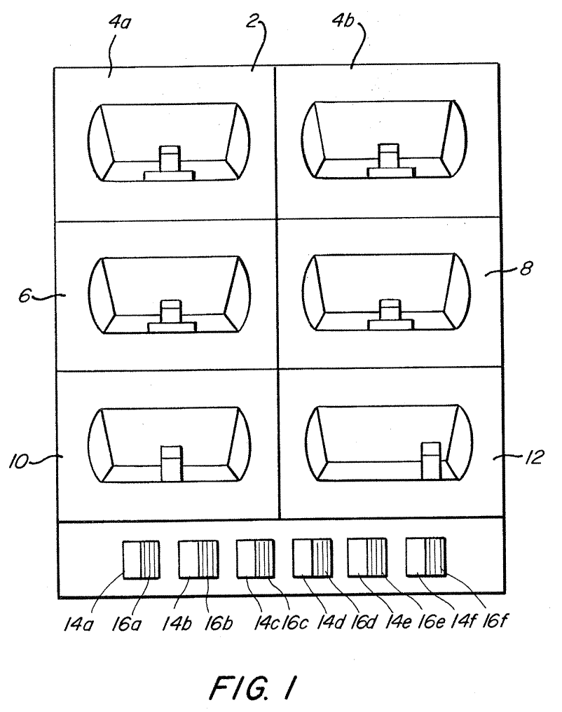

FIG. 1 is a top view of a multiple charging unit 1 according to an embodiment of the invention. The multiple charging unit 1 has a housing 2, charging units 4a-b, 6, 8, 10, 12, first display units 14a-f, and second display units 16a-f. Charging units 4a-b6, 8, 10, and 12 can be removably interchangeable with other charging units and can be configured to charge a variety of electronic devices and/or batteries. For example, charging unit 4a can be used to charge a cell phone while charging unit 4b can be used to charge another cell phone. Also, charging unit 6 can be used to charge a Blackberry® while charging unit 8 can be used to charge a PSP® or a PDA. In addition, charging unit 10 can be used to charge an iPod® while charging unit 12 can be used to charge another cell phone like a Sidekick®.

Charging units 4a-b, 6, 8, 10, and 12 can be charging one at a time, or concurrently with other charging units. Although only a few electronic devices are represented here, it can be seen that the charging units can also be adapted to charge other electronic devices or batteries. The charging units 4a-b, 6, 8, 10 and 12 can be labeled for easy identification of the electronic device or battery it will charge. The charging units 4a-b, 6, 8, 10 and 12 may have a similar shape or size for easy storage.

First display units 14a-f can be used to indicate when the charging units are active such as when the charging units are charging an attached battery or electronic device. The indication can be, for example, a light bulb or LED lighting up. Each first display unit can correspond to a specific charging unit. For example, first display unit 14a can correspond to charging unit 4a, first display unit 14b can correspond to charging unit 4b, first display unit 14c can correspond to charging unit 6, first display unit 14d can correspond to charging unit 8, first display unit 14e can correspond to charging unit 10, and first indicator charging unit 14f can correspond to charging unit 12.

Second display units 16a-f can be used to indicate when the charging units are transmitting data such as when the electronic devices attached to the charging units are communicating with an outside electronic device, between two attached electronic devices, or transmitting data to or from the data retention unit (not shown). The indication can be, for example, a light bulb or LED lighting up. Each second display unit 16 can correspond to a specific charging unit. For example, second display unit 16a can correspond to charging unit 4a, second display unit 16b can correspond to charging unit 4b, second display unit 16c can correspond to charging unit 6, second display unit 16d can correspond to charging unit 8, second display unit 16e can correspond to charging unit 10, and second indicator charging unit 16f can correspond to charging unit 12.

The first and second display units are sufficiently different from each other such that a user can distinguish them apart. For example, if the indicator is a light bulb for the first display unit and an LED for the second display unit, the light bulb may be red while the LED may be green.

Furthermore, although FIG. 1 depicts first display units and second display units in an alternating pattern with the first display unit on the left and the second display unit on the right, other patterns and placements of the first and second display units are also possible.

A data retention unit (not shown) can be attached or contained within the housing unit for storing data from attached electronic devices and retaining the data from the attached electronic device after the attached electronic device has been detached. The data retention unit could also transmit stored data to an attached electronic device. Data stored can include for example, songs, phonebooks, calendars, videos, text messages, picture messages, pictures, etc.

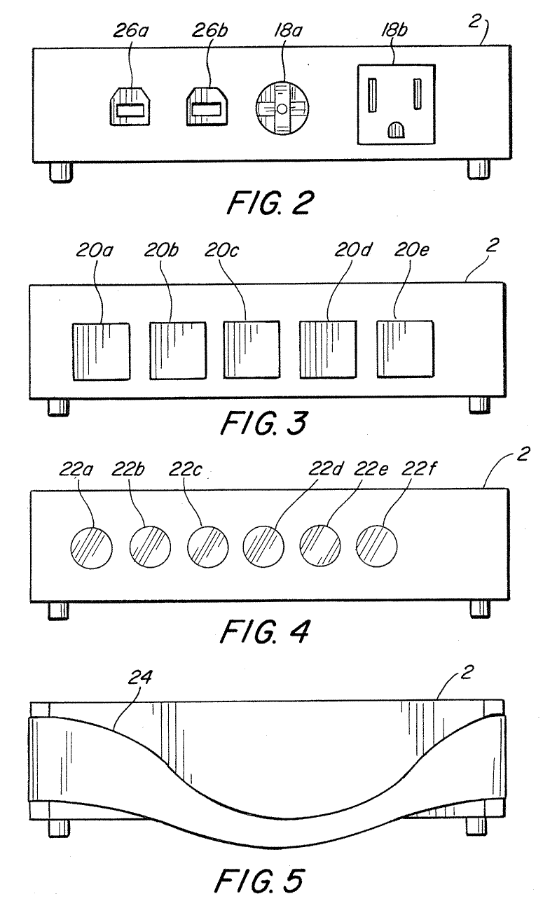

FIG. 2 is a view of the back side of the invention. FIG. 2 shows a housing 2 with two ports 16a-b, which are a part of the communication unit, and two power adapters 18a-b which are part of the power distribution unit. The communication unit can be used to allow attached electronic devices to communicate with an outside electronic device. Port 26a and 26b can be, for example, USB ports or firewire® ports. Port 26a could also be a USB port while port 26b could also be a firewire® port. In addition the communication unit could also have wireless communication capabilities (not shown). It is contemplated that more than one electronic device may communicate with the outside electronic device even though there may be only one connection from the outside electronic device to the communication unit.

The power distribution unit can receive power from an outside source and covert voltages such that each of the charging units receives the correct voltage. Power adapter 18a can be, for example, a car charging adapter while power adapter 18b can be, for example, an AC adapter.

FIG. 3 is a view of the left side of the invention. FIG. 3 shows the housing unit 2 with storage units 20a-e. Storage units 20a-e can be used to store charging units which have been removed from the housing unit and are unattached to the housing unit.

FIG. 4 is a view of the right side of the invention. FIG. 4 shows the housing unit 2 with third display units 22a-f. Third display units 22a-f can be used to indicate when the charging units are finished charging an attached battery or an attached electronic device. It is contemplated that the indication can be for example a light bulb or LED lighting up. It is contemplated that each of the second display units can correspond to a specific charging unit. For example, third display unit 22a can correspond to charging unit 4a, s third display unit 22b can correspond to charging unit 4b, third display unit 22c can correspond to charging unit 6, third display unit 22d can correspond to charging unit 8, third display unit 22e can correspond to charging unit 10, and third display unit 22f can correspond to charging unit 12.

FIG. 5 is a view of the back of the invention. FIG. 5 shows a housing unit 2 with a strap 24. The strap 24 can be used to carry the invention and can be placed over a user's shoulder.

Although each of the Figures depict a side of the invention such as the top, front, back, left, or right side, it is contemplated that the various components of the invention can be located in alternative positions. For example, the storage units 20a-e could be located on the right side of the invention instead of the left side of the invention or the third display units 22a-f could be located on the top side of the invention instead of right side of the invention.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A charging apparatus for charging a plurality of electronic devices, comprising:
a housing;
a power distribution unit within the housing;
a plurality of charging units connected to the power distribution unit wherein at least two of the plurality of charging units are adapted to attach to two different electronic devices, and the power distribution unit converts voltages such that each of the plurality of charging units receives the correct voltage; and
a communication unit connected to the power distribution unit and at least one of the plurality of charging units for communicating data with an outside electronic device.

2. The charging apparatus of claim 1, wherein at least one of the plurality of charging units is adapted to attach to a battery without an electronic device attached to the battery.

3. The charging apparatus of claim 2, wherein at least one of the plurality of charging units is removably interchangeable with other charging units not currently connected to the power distribution unit.

4. The charging apparatus of claim 3, wherein the at least one of the plurality of charging units is capable of communicating data with an attached electronic device.

5. The charging apparatus of claim 4 wherein the communication unit works in conjunction with the at least one of the plurality of charging units capable of communicating data with the attached electronic device, to allow the outside electronic device to communicate data with the attached electronic device, and at least two of the plurality of charging units allow two attached electronic devices to communicate with each other.

6. The charging apparatus of claim 5, wherein the housing further comprises first display units to indicate whether each of the plurality of charging units is charging an attached battery or an attached electronic device, and second display units to indicate whether each of the plurality of charging units is transmitting data.

7. The charging apparatus of claim 6, wherein the housing further comprises a third display to indicate whether each of the plurality of charging units has finished charging an attached battery or an attached electronic device.

8. The charging apparatus of claim 7, further comprising a data retention unit for storing data from the attached electronic device and retaining the data from the attached electronic device after the attached electronic device has been detached, and for transmitting stored data to the attached electronic unit.

9. The charging apparatus of claim 8, further storage units for storing charging units that are not connected to the power distribution unit, and a strap attached to the housing.

10. The charging apparatus of claim 1, wherein one of the plurality of charging units is adapted to charge a music player and one of the plurality of charging units is adapted to charge a personal digital assistant.

11. The charging apparatus of claim 1, wherein one of the plurality of charging units is adapted to charge a cell phone and one of the plurality of charging units is adapted to charge a camera.

12. The charging apparatus of claim 1, wherein the power distribution unit is adapted to receive a car charger.

13. The charging apparatus of claim 1 wherein the housing unit is integrated into a vehicle.

14. A charging apparatus for charging a plurality of electronic devices, comprising:
a housing;
a power distribution unit within the housing;
a plurality of charging units connected to the power distribution unit wherein
at least two of the plurality of charging units are adapted to attach to two different electronic devices,
at least one of the plurality of charging units is adapted to attach a battery without an electronic device attached to the battery,
at least one of the plurality of charging units is removably interchangeable with other charging units not currently connected to the power distribution unit, and
the power distribution unit converts voltages such that each of the plurality of charging units receives the correct voltage; and
a communication unit connected to the power distribution unit for communicating data with an outside electronic device.

15. The charging apparatus of claim 14 and at least one of the plurality of charging units is capable of communicating data with an attached electronic device.

16. The charging apparatus of claim 15, wherein the communication unit works in conjunction with the at least one of the plurality of charging units capable of communicating data with the attached electronic device, to allow the outside electronic device to communicate data with the attached electronic device, and at least two of the plurality of charging units allow two attached electronic devices to communicate with each other.

17. The charging apparatus of claim 16, wherein the housing further comprises
first display units to indicate whether each of the plurality of charging units is charging an attached battery or an attached electronic device,
second display units to indicate whether each of the plurality of charging units is transmitting data, and
third display units to indicate whether each of the plurality of charging units has finished charging an attached battery or an attached electronic device, and
a data retention unit for storing data from the attached electronic device and retaining the data from the attached electronic device after the attached electronic device has been detached, and for transmitting stored data to the attached electronic unit.

18. The charging apparatus of claim 17 further comprising storage units for storing charging units that are not connected to the power distribution unit and a strap attached to the housing.

19. The charging unit of claim 14 wherein one of the plurality of charging units is adapted to charge a music player, one of the plurality of charging units is adapted to charge a personal digital assistant, one of the plurality of charging units is adapted to charge a cell phone, and one of the plurality of charging units is adapted to charge a camera.

20. A charging apparatus for charging a plurality of electronic devices, comprising:
a housing;
a power distribution unit within the housing, the power distribution unit adapted to receive a car charger;
a plurality of charging units connected to the power distribution unit wherein
one of the plurality of charging units is adapted to charge an attached music player,
one of the plurality of charging units is adapted to charge an attached personal digital assistant,
one of the plurality of charging units is adapted to charge an attached cell phone,
one of the plurality of charging units is adapted to charge an attached camera,
at least one of the plurality of charging units is adapted to attach a battery without an electronic device attached to the battery,
at least one of the plurality of charging units is removably interchangeable with other charging units not currently connected to the power distribution unit,
at least one of the plurality of charging units is capable of communicating data with an attached electronic device,
at least two of the plurality of charging units allow two attached electronic devices to communicate with each other,
and the power distribution unit converts voltages such that each of the plurality of charging units receives the correct voltage;
a communication unit connected to the power distribution unit and at least one of the plurality of charging units for communicating data with an outside electronic device, wherein the communication unit works in conjunction with the at least one of the plurality of charging units capable of communicating data with the attached electronic device, to allow the outside electronic device to communicate data with the attached electronic device;
first display units to indicate whether each of the plurality of charging units is charging a battery or an attached electronic device;
second display units to indicate whether each of the plurality of charging units is transmitting data; and
third display units to indicate whether each of the plurality of charging units has finished charging a battery or an attached electronic device; and
a data retention unit for storing data from the attached electronic device and retaining the data from the attached electronic device after the attached electronic device has been detached, and for transmitting stored data to the attached electronic unit.
